(19) United States
(12) Patent Application Publication
(10) Pub. No.: US 2024/0061934 A1
(43) Pub. Date: Feb. 22, 2024

(54) TECHNIQUES FOR MITIGATING MANIPULATIONS OF AN ONBOARD NETWORK OF A VEHICLE

(71) Applicant: Robert Bosch GmbH, Stuttgart (DE)

(72) Inventors: Carsten Nobbe, Remchingen (DE); Joachim Graf, Gueglingen (DE)

(21) Appl. No.: 18/452,872

(22) Filed: Aug. 21, 2023

(30) Foreign Application Priority Data
Aug. 22, 2022 (DE) 10 2022 208 647.3

(51) Int. Cl. G06F 21/56; G06F 21/55

(52) U.S. Cl. CPC G06F 21/56; G06F 21/554; G06F 2221/034

(57) ABSTRACT

A method for averting manipulations of an onboard network of a vehicle. The method includes receiving a signature of an anomaly prevailing in the onboard network and carrying out a first countermeasure which transfers the vehicle and/or at least one of its components into a predetermined safe state. The first countermeasure is selected based on the signature. The method also includes the implementation of a second countermeasure to at least partially restore a functional scope of the vehicle. The first and/or the second countermeasure for the prevailing anomaly is/are selected dynamically from various available countermeasures based on status information with respect to the vehicle and/or the prevailing anomaly.

### BACKGROUND INFORMATION

More recently, vehicles are increasingly being linked into open contexts (that is, the vehicles have one or more interfaces via which data is received and/or transmitted during operation, the data in turn being used for the operation of the vehicle). In this context, in some cases existing interfaces are also being used to a considerably greater extent, (e.g., continuously during driving). In addition, the complexity of the components of the vehicles and especially their software is increasing constantly. Moreover, the software of the vehicles is being updated in ever more diverse ways during operation.

As a result, possibilities for manipulating the software of the components of the vehicles are likewise becoming more numerous.

In some methods of the related art, the detection and, above all, the mitigation of manipulations (that is, rectification of the manipulation so that a defined (safe) state is achieved, and/or at least alleviation or removal of the effects of manipulations) are associated with considerable effort and therefore time delay. In many examples, a manipulation may be detected more or less by chance (e.g., during a test drive). As a result, a measure is then developed for mitigating the manipulation (e.g., a software update). The manipulated software of a component (e.g., of a control unit) may then be reset during a visit to a service station, for example, and the manipulation thereby eliminated. In other techniques, software may be transmitted from a remote computer system, with whose aid the manipulated software of a component (e.g., of a control unit) is reset, thus rectifying the manipulation. In both cases, the period of time between the detection of the manipulation and the mitigation of the manipulation may be considerable. In some circumstances, the operation of the vehicle is disrupted during this period of time (e.g., a predetermined safety criterion is no longer satisfied). In some cases, the vehicle may no longer be roadworthy or its range of functions may be severely affected. Therefore, improved techniques are desirable for mitigating the manipulation of software.

### SUMMARY

A first general aspect of the present invention relates to a method for mitigating manipulations of an onboard network of a vehicle. According to example embodiment of the present invention, the method includes receiving a signature of an anomaly prevailing in the onboard network and carrying out a first countermeasure which transfers the vehicle and/or at least one of its components into a predetermined safe state. The first countermeasure is selected based on the signature. The method also includes the implementation of a second countermeasure to at least partially restore a functional scope of the vehicle. The first and/or the second countermeasure for the prevailing anomaly is/are selected dynamically from various available countermeasures based on status information of the vehicle and/or the prevailing anomaly.

A second general aspect of the present invention relates to a system which is designed to execute the method according to the first general aspect.

In some cases, the techniques of the first and second general aspects of the present invention may have one or more of the following advantages.

First of all, due to a multistage reaction which includes at least the first and second countermeasures, in some cases, the techniques of the present invention may improve both the (operating) safety and an available functional scope of a vehicle (or one of its components), as well as the security against manipulation or exploitation of data by unauthorized third parties. It may be that in some techniques of the related art, one or more countermeasures is/are carried out. However, they focus exclusively or mainly on achieving one of the goals indicated above (e.g., (re-)establishing the operating safety). For instance, according to the present invention, the first countermeasure may include switching off a first component without delay (e.g., within 100 ms after detecting the anomaly) and shifting a functionality of the first component to a second component. For example, an attack on a brake booster may be detected. It may be switched off. The functionality of the brake booster may then be taken over to some extent by another component of the brake system. In this way, the vehicle may first of all be brought into a safe state in which a brake-boosting functionality is available. The result of the attack and/or the first countermeasure may now be a reduction of a range of functions of the vehicle (i.e., a functional scope of the onboard network or its components). In the case indicated, for example, after the brake booster is switched off, there is no longer a redundancy of the brake-boosting function. In resetting a software of the brake booster and subsequent reactivation of the brake booster, the second countermeasure may now rectify the consequences of the attack and (at least partially) restore the functional scope of the vehicle. Therefore, in some situations, by carrying out the first and second countermeasures, the vehicle may be operated safely and with as unrestricted a range of functions as possible. This may afford sufficient time to close a vulnerable spot in the onboard network without compromising the operating safety of the vehicle or restricting its range of functions in disorderly fashion. In some cases, the time needed to close the vulnerable spot may amount to weeks or even months—the vulnerable spot must possibly first be identified and an appropriate software update developed and tested. In some techniques of the related art, the vehicle can only be operated with a considerable restriction of its range of functions during this time period.

Secondly, in some cases the operating safety and/or the functional scope (or another property) of the vehicle may be improved, in that for an anomaly having a specific signature (e.g., an attack of a certain kind on a specific component of the onboard network), different first or second countermeasures are selected dynamically in different situations. For example, a different first and/or second countermeasure may be selected in response to the appearance of an anomaly with a specific signature for the first time, than in response to a further appearance. In the case of the first appearance, a component which was affected by the attack may simply be reset. After a further appearance, a software of the component may be overwritten with a safe version. In other examples, after a first appearance of the anomaly, an affected component may fully resume its function. After another appearance of the anomaly, the component may only resume its function in a limited manner. In this way, the selection of the countermeasures may be adapted purposefully to the operating situation of the vehicle. In the example, a first-time appearance of an anomaly may be rectified with relatively gentle interventions in the onboard network. If the anomaly appears again, more serious interventions may be selected. Thus, in some situations, a compromise may be found between the impairment of the operation of the vehicle owing to the countermeasures, and the prevention of the repeated appearance of an anomaly. So, for example, the permanent blocking of a component after a one-time appearance of an anomaly could lead to quite a far-reaching loss of function of the vehicle over what could be a long time (e.g., until a vulnerable spot has been closed by a software update). On the other hand, only restarting or resetting the software may lead to the same component being manipulated again and again, with the risks associated with that. The techniques of the present invention make it possible to adapt the countermeasures to these circumstances. Criteria for the dynamic selection of the first and second countermeasures as the repeated appearance of an anomaly are possible and are explained in greater detail below.

A third general aspect of the present invention relates to a method for mitigating manipulations of an onboard network of a vehicle. According to an example embodiment of the present invention, the method includes receiving a signature of an anomaly prevailing in the onboard network and carrying out a first countermeasure which transfers the vehicle and/or at least one of its components into a predetermined safe state. The first countermeasure is selected based on the signature. The method also includes the implementation of a second countermeasure to at least partially restore a range of functions of the vehicle. The method further includes receiving a software update so as, after the second countermeasure has been carried out, to close a vulnerable spot in the onboard network which a manipulation, that caused the prevailing anomaly, has exploited.

A fourth general aspect of the present invention relates to a system which is designed to execute the method according to the third general aspect of the present invention.

In some cases, the techniques of the third and fourth general aspects of the present invention may have one or more of the following advantages.

As evident, the techniques of the third and fourth general aspects, like the techniques of the first and second general aspects, include carrying out the first and second countermeasures. Therefore, the techniques of the third and fourth general aspects may have the advantages, described above and hereafter, which are associated with the implementation of the first and second countermeasures. The first and second countermeasures in the techniques of the third and fourth general aspects may also be selected dynamically (but do not have to be, the assignment to the corresponding signature may also be static). In addition, in the techniques of the third and fourth general aspects, the third downstream measure of receiving the software update may further increase the security of the onboard network with respect to manipulation or exploitation of data by unauthorized third parties.

Several terms are used in the following manner in the present disclosure:

A “component”, a “module” or a “unit” in the present disclosure may be any software and/or hardware suitable for carrying out described methods and/or for providing a described function. For instance, a “component”, a “module” or a “unit” may be a software component, a software module or a software unit (that is, the function of the component/the module is defined in software, which may be run on suitable hardware). In other examples, a “component”, a “module” or a “unit” may be a hardware component, a hardware module or a hardware unit (that is, the function of the component/the module is defined in hardware, e.g., in the form of an adapted processor). Again, in other examples, the function of the component/the module may be defined in software and in hardware.

A “component”, a “module” or a “unit” (e.g., of an onboard network) in the present disclosure may have hardware resources available which include at least one processor for executing commands and memory for storing at least one software component. The term “processor” also includes multi-core processors or multiple separate components which take over (and possibly share) the tasks of a central processing unit. A component may perform tasks independently (e.g., measuring tasks, monitoring tasks, control tasks, communication tasks and/or other work tasks). In some examples, however, a component may also be controlled by another component. A component may be delimited physically (e.g., with its own housing), or else integrated into a higher-level system. A component may be a control unit or a communication device of the vehicle. A component may be an embedded system. A component may include one or more microcontrollers.

Accordingly, a “component of a vehicle” is a component as described above, which is located in a vehicle (that is, is moved together with it). In this context, the component may be installed permanently in the vehicle. However, a component of a vehicle may also be a mobile component which is present (only) from time to time in the automobile (e.g., a mobile device of a passenger).

An “embedded system” is a component which is linked (embedded) into a technical context. In this case, the component takes over measuring tasks, monitoring tasks, control tasks, communication tasks and/or other work tasks.

A “(dedicated) control unit” is a component which (exclusively) controls one function of a vehicle. For instance, a control unit may take over an engine management, a control of a brake system or a control of an assistance system. In this context, a “function” may be defined on various levels of the vehicle (for example, a single sensor or actuator may be used for a function, but a variety of assemblies, which are combined to form one larger functional unit, may also be employed).

In principle, the term “software” or “software component” may be any part of a software of a component (e.g., of a control unit) of the present disclosure. In particular, a software component may be a firmware component of a component of the present disclosure. “Firmware” is a software which is embedded in (electronic) components and performs basic functions there. Firmware is permanently linked functionally to the respective hardware of the component (so that one is not usable without the other). It may be stored in a non-volatile memory such as a flash memory or an EEPROM.

The term “update” or “software update” includes any data which, directly or after suitable processing steps, forms a software (component) of a component according to the present disclosure. The update may contain executable code or code yet to be compiled (which is stored in the memory of the corresponding component).

The term “anomaly” includes a deviation from the regular operation of the vehicle (e.g., one or more components is/are not regularly configured, the behavior of one or more components deviates from a behavior during regular operation and/or one or more operating parameters of one or more components deviates from nominal values during normal operation, etc.). An anomaly may be a manipulation of the components of the vehicle (e.g., of its software) or appear as the result of a manipulation of the components of the vehicle (e.g., of its software).

The term “manipulation” in the present disclosure includes any change of a software of a component of a vehicle. The change may be the result of an attack (e.g., the deliberate exertion of influence by a third party), but may also be the result of an accidental or unintentional action.

The term “vehicle” includes any devices which transport passengers and/or freight. A vehicle may be a motor vehicle (for example, an automobile or a truck), but may also be a rail vehicle. However, floating and flying devices may also be vehicles. Vehicles may be at least semi-autonomously operating or be assisted.

An “onboard network” may be any internal network of a vehicle in which the components of the vehicle are contained and via which components of the vehicle communicate (the components in the present disclosure are referred to as part of the onboard network). In some examples, an onboard network is a near-field network. An onboard network may employ one or several near-field communication protocols (e.g., two or more near-field communication protocols). The near-field communication protocols may be wireless or wire-bound communication protocols. The near-field communication protocols may include a bus protocol (for example, CAN, LIN, MOST, FlexRay or Ethernet). The near-field communication protocols may include a Bluetooth protocol (e.g., Bluetooth 5 or later) or a WLAN protocol (e.g., a protocol of the IEEE-802.11 family, e.g., 802.11h or a later protocol). An onboard network may contain interfaces for communication with systems outside of the vehicle and thus may also be linked into other networks. However, the systems outside of the vehicle and the other networks are not part of the onboard network.

The expression “detection of an anomaly” means that certain events (e.g., signals or their nonappearance) are interpreted according to predetermined rules in order to recognize a state which deviates from a regular operation of the vehicle. For instance, an anomaly may be a manipulation of the software of the vehicle or may point to a manipulation of the software of the vehicle.

A “function” in the present disclosure is any capability of the components to accomplish a specific task in the vehicle or a capability of the vehicle as a whole to accomplish a specific task. For instance, the task may be the operation of one or more systems of the vehicle (e.g., engine, transmission, assistance systems, sensors, climate control, infotainment, communication interfaces, etc.). In other examples or in addition, the task may lie in the execution of a driving maneuver (or a part of a driving maneuver) and may be carried out autonomously or in assisted fashion (the driving maneuvers may be of varying complexity, e.g., braking maneuvers, steering maneuvers, driving along certain routes or parking). In yet other examples, the task may lie in the provision of data (e.g., sensor data) (which in turn may be used for other tasks). A “functional scope” accordingly is the totality of the functions of the vehicle or of its components.

A “safe state” denotes a state in which the operating safety of the vehicle is ensured in terms of a defined safety criterion and/or a defined safety goal. The safety criterion or the safety goal may place one or more demands on the performance capability of the vehicle and/or its components (that is, the vehicle and/or its components operate with a certain performance capability with regard to one or more functions). A safe state may include particularly that passengers and the environment of the vehicle are protected from harm in the best manner possible. A safe state may include that critical systems of the vehicle (e.g., braking, chassis and suspension, assistance systems, systems for autonomous driving or active systems for passenger and or environmental safety) function in normal operation (that is, according to a specification), or function less well by at most a predetermined maximum degree than in normal operation (for example, a braking operation may be carried out with a braking force lower by no more than a maximum amount than in normal operation).

An “operating status” includes any status information with respect to the vehicle and/or its components and/or the surroundings of the vehicle. An operating status may be defined by one or more status parameters of the vehicle and/or its components and/or its surroundings. The status parameters may be measured or calculated parameters of the vehicle and/or of its components and/or variables derived from them (e.g., a temperature of a component or a derived variable which indicates a state of the vehicle and/or its components). An operating status may be ascertained by monitoring the vehicle and/or its components (for example, it is possible to monitor whether the vehicle and/or its components is/are behaving according to a certain specification).

### BRIEF DESCRIPTION OF THE DRAWINGS

FIG. 1 illustrates, as an example, the sequences of the methods of the present invention.

FIG. 2 is a schematic representation of a vehicle having a system for mitigating manipulations of an onboard network, according to an example embodiment of the present invention.

### DETAILED DESCRIPTION OF EXAMPLE EMBODIMENTS

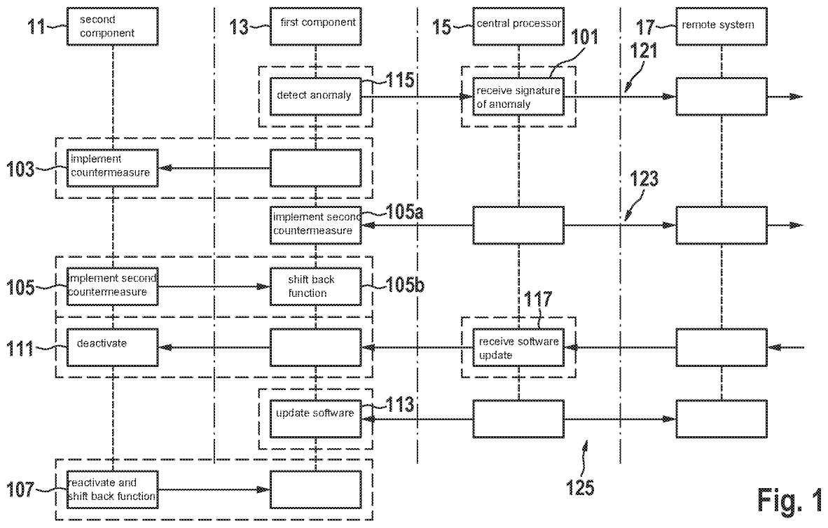

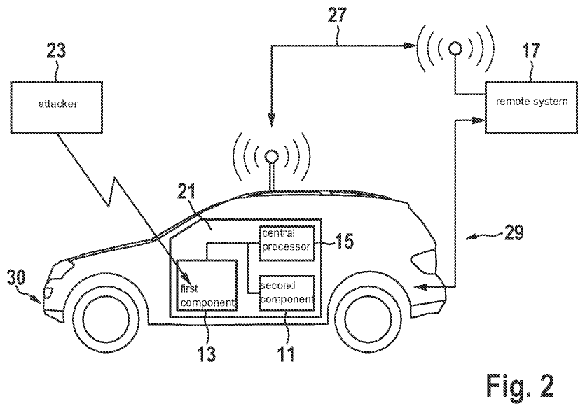

First of all, the central aspects of the techniques of the present invention are explained with reference to FIG. 1 and FIG. 2. After that, a few modifications are discussed.

FIG. 1 illustrates as example the sequences of the methods of the present invention. FIG. 2 is a schematic representation of a vehicle having a system for mitigating manipulations of an onboard network.

The example in FIG. 1 and FIG. 2 shows a first component 13 (e.g., a first embedded system, for instance, a first control unit), a second component 11 (e.g., a second embedded system, for instance, a second control unit), a central processor 15 of the vehicle and a remote system 17 (also referred to as “backend”). First component 13, second component 11 and central processor 15 are part of onboard network 21. In each column of FIG. 1, actions are shown which are executed by the respective component.

The techniques for mitigating manipulations of an onboard network 21 of a vehicle 30 include receiving 101 a signature of an anomaly prevailing in onboard network 21.

In some examples, an anomaly (e.g., a manipulation) may be detected by a device for detecting a manipulation of a component, affected by an anomaly, of the onboard network. For example, in FIG. 1, an anomaly is detected 115 in first component 13 (an attacker 23 may have manipulated first component 13 previously). In other examples (or additionally), a central device may be provided for detecting manipulations. The central device for detecting manipulations may be designed to recognize anomalies (e.g., manipulations) in a plurality of components 11, 13, 15 of the onboard network. In some examples, multiple central devices for detecting manipulations may be provided, which are responsible for various areas (e.g., spatial or functional areas) in the vehicle.

The anomalies may be detected in various ways. In some examples, a software of a component (or part thereof) may be analyzed. If the software deviates in one or more aspects from an anticipated software, an anomaly may be recognized (for example, if certain abnormalities appear). For instance, the check may include a check of the integrity of the software (e.g., a step-by-step or bit-by-bit) comparison of the software to a software of integrity). Additionally or alternatively, an authenticity of a software may be checked (e.g., by one or more authentication steps, for instance, the verification of one or more digital signatures). If the software is recognized as inauthentic, an anomaly may be recognized. Additionally or alternatively, a communication to and/or from the corresponding component may be analyzed (for example, a programming process of the software of the component is recognized). If certain communication to and/or from the corresponding component occurs, an anomaly may be recognized. Furthermore or alternatively, a software (or a part thereof) may be analyzed. In all examples, an anomaly may be detected on the basis of one or more criteria (which, for instance, are weighted in a certain manner or the criteria may be evaluated in parallel or sequentially).

The signature of a (prevailing) anomaly in the onboard network identifies the anomaly (which is why it is also said that a certain anomaly has a signature). An anomaly may be caused by a specific manipulation (e.g., the anomaly points to the presence of the manipulation, the anomaly appears as a result of the manipulation). Additionally or alternatively, an anomaly may be a manipulation (that is, detection of the anomaly corresponds to the detection of the manipulation). In some examples, the anomaly may be related biuniquely to a specific manipulation. In other examples, an anomaly may be assigned to multiple manipulations (e.g., an anomaly may appear as the result of any of the multiple manipulations).

The identifying may be carried out in various ways relative to the format of the signature and the type of the identification. In some examples, the signature includes data which explicitly or implicitly determines a type of the anomaly (e.g., of the manipulation) (for example, in the form of a unique identifier of the type of a manipulation). In various examples, the types of anomalies may be differentiated in different granularity. Additionally or alternatively, the signature may identify the location of an anomaly and/or a component affected (e.g., first component 13 in FIG. 1).

In the example of FIG. 1 and FIG. 2, the signature is received at central processor 15. In this example (and also in general), central processor 15 may include a central device for mitigating manipulations (the central device for mitigating manipulations is designed to orchestrate countermeasures for a plurality of components of onboard network 21). In other examples, however, other components of onboard network 21 and/or of remote system 17 may also receive the signature (and/or contain a central device for mitigating manipulations).

The techniques of the present invention further include implementation 103 of a first countermeasure which transfers vehicle 30 and/or at least one of its components 11, 13, 15 into a predetermined safe state.

The first countermeasure is selected based on the signature. In some examples, one or more first countermeasures may be defined for an anomaly having a certain signature. If several different first countermeasures are available for selection, one of these countermeasures may be selected in the specific case (more about that below).

As described, the goal of the first countermeasure is to transfer vehicle 30 and/or at least one of its components 11, 13, 15 into a predetermined safe state (that is, a defined safety criterion is fulfilled or a defined safety goal is achieved). In other words, the intention is to end an unsafe state, (i.e., a defined safety criterion is not fulfilled or a defined safety goal is not achieved), which is produced by the prevailing anomaly and/or a manipulation causing it. In some examples, the goal of the countermeasure is to transfer several or all components involved in providing a certain function (e.g., a driving function) into a safe state.

In some examples, the first countermeasure may include at least a partial deactivation or blocking of first component 13 of onboard network 21 in which the prevailing anomaly has appeared. In some examples, only a part of first component 13 may be deactivated or blocked (for example, in the case of a more complex component having several subcomponents). In other examples, first component 13 may be completely deactivated or blocked. In yet other examples, several components may be at least partially deactivated or blocked. In each case, the result of the deactivation or blocking may be that the first component no longer performs its intended function and/or no longer communicates in the onboard network. Thus, in some situations, endangerment of the operating safety due to first component 13 may be ended (and the vehicle transferred into a safe state). For instance, first component 13 may be a brake component and the goal of a manipulation may be an overbraking of the vehicle. Switching off or blocking the first component may thwart this intention.

Alternatively or additionally, the first countermeasure may include at least partial deactivation of a first function of vehicle 30. For instance, the first function may be made available at least to some extent by first component 13.

Alternatively or additionally, the first countermeasure may include shifting a function of first component 13 in which the prevailing anomaly has appeared, to a second component 11. In this way, a safety-critical function in the vehicle may continue to be available/may again be made available. In many cases, vehicles possess several components which are able to provide a certain function. For example, in some examples, even in normal operation, several components jointly may provide a function. The provision of the function may then be shifted completely to a portion of the components. Additionally or alternatively, redundant components may be provided in a vehicle in terms of making a function available. Providing of the function may then be shifted from a first component to a second redundant component. In the example above, the brake component may be a brake booster. The function of amplifying the braking force may likewise be made available by an E-booster. Shifting of the function in this case may include the provision of the brake boost by the E-booster. In other examples, a second sensor system may take over the provision of a certain monitoring function from a first sensor system (that is, the monitoring function is shifted from the first sensor system to the second sensor system).

As a further alternative or additionally, the first countermeasure may include changing a configuration and/or a function of first component 13 of the onboard network in which the prevailing anomaly has appeared (e.g., in which a manipulation has taken place), and/or of further components of the onboard network. For instance, the first component may be switched from a first configuration with an expanded functional scope to a second configuration with a limited functional scope (e.g., in which the first component communicates only to a limited extent with other components, or in which the first component provides only a basic function and no longer provides expanded functions, or in which the first component no longer provides a safety-critical function, but continues to provide a function not critical to safety).

As a further alternative or additionally, the first countermeasure may include changing an operating mode of first component 13 of the onboard network, in which the prevailing anomaly has appeared (e.g., in which a manipulation has taken place), and/or of further components of the onboard network. For example, an operating mode may be changed from a first operating mode in which the component performs more complex functions, to a second operating mode in which the component performs functions that are less complex. For instance, a component which provides an assisted or autonomous function may be shifted from a first operating mode with the provision of more complex driving maneuvers (e.g., driving faster than a certain speed and/or at a certain distance and/or under certain environmental conditions) to a second operating mode with the provision of driving maneuvers that are less complex. Additionally or alternatively, optional sub-functions of a function may be deactivated (e.g., a function is performed without communication with external systems).

As a further alternative or in addition, the first countermeasure may include transmitting a warning that an anomaly has been detected, to one or more interfaces (e.g., a user interface of the vehicle). For instance, a passenger may be prompted to at least partially take over a control function of the vehicle.

As mentioned, the first countermeasures described above may also be combined. For example, two of the first countermeasures described may be carried out in parallel or one after the other. Additionally or alternatively, multiple anomalies may be recognized in parallel or sequentially and corresponding countermeasures carried out.

The first countermeasure may be carried out in various ways. Similarly, various components of the vehicle or remote systems may participate in carrying out the first countermeasure. In one example, the components affected (e.g., first component 13 and second component 11 in FIG. 1) may themselves carry out the corresponding first measure(s). In these examples, the corresponding component may also receive the signature information (including the case in which the signature information is generated in the component itself). Additionally or alternatively, a central device for mitigating manipulations may carry out the first countermeasure and/or participate in its implementation (e.g., control one or more subcomponents of the component affected or else carry out the countermeasure from a distance). In some examples, a specific component (e.g., a central device for mitigating manipulations) may select a first countermeasure and instruct a further component to participate in implementing the countermeasure (e.g., by sending a corresponding message via the onboard network). The specific component which selects the first countermeasure may also be located in a remote system 17. In these examples, the method may further include checking in vehicle 30, whether the countermeasure selected is intended to be carried out (or is executable at all) in a present operating situation.

In some examples, the first countermeasure is intended to be carried out within a first predetermined time interval after an anomaly is detected (i.e., the first countermeasure is concluded within this time interval). In some examples, the first predetermined time interval may be 20 seconds to 2 ms. Additionally or alternatively, the time interval may be no longer than a predetermined fault-tolerance time (e.g., a time interval for which a specific fault can be tolerated without endangering the operating safety of the vehicle; for example, a fault-tolerance time according to the Standard ISO26262:2018 “Road vehicle—Functional safety”). These time intervals may be suitable for reducing the danger of damage due to a vehicle and/or one of its components being in an unsafe state. Thus, it may be necessary that the first countermeasures be selected accordingly, so that implementation is possible within the first time interval. In some examples, the first countermeasure may be carried out by one or more components within the vehicle (e.g., in order to permit implementation within the first time interval).

Furthermore, the techniques of the present invention include implementation 105 of a second countermeasure to at least partially restore a functional scope of vehicle 30. In some examples, the implementation of the second countermeasure is started after the implementation of the first countermeasure has been started (e.g., a predetermined length of time later). Additionally or alternatively, the second countermeasure may be ended after the first measure has ended (however, the implementation of the second countermeasure may already be started before the implementation of the first countermeasure has ended). In other examples, the first and second countermeasures are carried out sequentially (that is, the implementation of the first countermeasure is ended when the implementation of the second countermeasure is begun).

As explained above, a functional scope of vehicle 30 denotes the totality of functions of the vehicle (or of one of its components). As likewise described, a function may be any capability of components 11, 13 to accomplish a certain task in vehicle 30 or a capability of vehicle 30 as a whole to accomplish a certain task. In this context, reducing the functional scope may mean that a certain function is no longer provided, or is provided only for a limited time (e.g., a function of the autonomous or assisted driving is no longer provided; a certain sensor modality is no longer available; a component takes over a certain function, but for reasons of design, is only able to make it available for a certain period of time, etc.). Additionally or alternatively, a reduction of the functional scope may mean providing a function to a limited extent compared to normal operation (e.g., a function of the autonomous or assisted driving is provided only in a limited number of operating situations and/or in a reduced driving-parameter space; a sensor modality is provided, but with a reduced quality (resolution, image rate)). Furthermore or alternatively, the functional scope may pertain to characteristics with respect to the operating safety of the vehicle or its components. For example, the functional scope may be determined by characteristics such as redundancy of the provision of a certain function (e.g., when a vehicle has two components that are able to perform a certain function and therefore is designed redundantly in terms of this function, then the loss of one of the two components represents a reduction of the functional scope of the vehicle—the vehicle no longer redundantly supplies the function in question).

In each of the aforesaid examples, an at least partial restoration of the functional scope of vehicle 30 may include that a reduction of the functional scope (as a result of the first countermeasure) is at least partially remedied again (that is, the functional scope is at least partially available again during normal operation). In some examples, the functional scope of vehicle 30 is completely restored (that is, the functional scope is available again in normal operation).

The second countermeasure may thus at least partially remove again an effect of the first countermeasure on the performance capability of the vehicle. Compared to some techniques of the related art, the vehicle may thus be available again (faster) with a larger range of functions.

In some examples, the second countermeasure may be carried out within a second time interval after the anomaly is detected (that is, the implementation of the second countermeasure is finished within the second time interval). For example, the second time interval may be shorter than a day (e.g., shorter than two hours or shorter than ten minutes). For instance, the second time interval may be longer than one minute (e.g., longer than ten minutes).

The second countermeasure may be carried out in various ways (similar to the implementation of the first countermeasure). Likewise, various components of vehicle 30 or remote systems may participate in carrying out the second countermeasure. In one example, the components affected (e.g., first component 13 and second component 11 in FIG. 1) may themselves carry out the corresponding first measures. Additionally or alternatively, a central device for mitigating manipulations may carry out the second countermeasure and/or be participant in carrying it out (e.g., control one or more subcomponents of the component affected or else carry out the countermeasure from a distance). In some examples, a specific component (e.g., a central device for mitigating manipulations) may select a second countermeasure and instruct a further component to participate in implementing the countermeasure (e.g., by sending a corresponding message via the onboard network). The specific component which selects the second countermeasure may also be located in a remote system.

In some examples, the second countermeasure may include resetting a software of first component 13 of onboard network 21 in which the prevailing anomaly has appeared (e.g., in which a manipulation has taken place), and or of further components of the onboard network (for example, the software of first component 13 is reset to a last authenticated state that corresponds to a version of the software used prior to detecting the anomaly). The software for the resetting may be stored in the vehicle itself (e.g., in each case in the component affected or in a central storage device, for instance, a central device for mitigating manipulations). In other examples, the software for the resetting may be obtained from a remote system 17 (e.g., via an air interface 27 of the vehicle).

Additionally or alternatively, the second countermeasure may include updating a software of first component 13 of onboard network 21, in which the prevailing anomaly has appeared (e.g., in which a manipulation has taken place). Additionally or alternatively, the second countermeasure may include updating the software of further components of onboard network 21 (that is, in addition to or instead of first component 13). For example, the further components may be components which produce a communication path to first component 13 (e.g., a communication interface or a central communication node of the vehicle). The updating of the software may include replacing a software used prior to detecting the anomaly, with a more up-to-date version of the software. The software for the updating may be stored in vehicle 30 itself (e.g., in each case in the component affected or in a central storage device, for instance, a central device for mitigating manipulations). In other examples, the software for the updating may be obtained from a remote system 17 (e.g., via an air interface 27 of the vehicle).

Furthermore or alternatively, for example, the second countermeasure may include reactivation of first component 13 or lifting a blockade of first component 13 of the onboard network in which the prevailing anomaly has appeared (e.g., in which a manipulation has taken place). In some examples, only a part of first component 13 which was switched off or blocked may be reactivated (for example, in the case of a more complex component having several subcomponents).

Furthermore or alternatively, for example, the second countermeasure may include shifting a function back from second component 11 to first component 13, in which the prevailing anomaly has appeared (e.g., in which a manipulation has taken place). In some examples, the shift back may include reversing the actions described above with respect to the first countermeasure of the shift (that is, restoration of the situation prior to carrying out the first countermeasure of the shift).

Furthermore or alternatively, for example, the second countermeasure may include changing a configuration of first component 13 of the onboard network, in which the prevailing anomaly has appeared (e.g., in which a manipulation has taken place), and/or of further components of the onboard network. In some examples, the change of the configuration may include reversing the actions described above with respect to the first countermeasure of the change of the configuration (that is, restoration of the situation prior to carrying out the first countermeasure of changing the configuration). For instance, the first component may be switched from a second configuration having a limited range of functions to a first configuration having an expanded range of functions.

Furthermore or alternatively, for example, the second countermeasure may include changing an operating mode of first component 13 of the onboard network, in which the prevailing anomaly has appeared (e.g., in which a manipulation has taken place), and/or of further components of the onboard network. In some examples, the change of the operating mode may include reversing the actions described above with respect to the first countermeasure of the change of the operating mode (that is, restoration of the situation prior to carrying out the first countermeasure of changing the operating mode). For example, an operating mode may be changed from a second operating mode in which the component performs functions that are less complex, to a first operating mode in which the component performs a more complex function.

As mentioned, the second countermeasures described above may also be combined. For example, two of the second countermeasures described may be carried out in parallel or one after the other.

In the example of FIG. 1, as a second countermeasure, the software of first component 13 is updated 105a. In addition, after the software of first component 13 has been updated, the function shifted previously to second component 11 is shifted back 105b again to the first component. A functional scope of vehicle 30 may thus be restored.

According to the techniques of the present invention, the first and/or the second countermeasure for the prevailing anomaly is/are selected dynamically from various available countermeasures based on status information with respect to vehicle 30 and/or the prevailing anomaly/anomalies. In some examples, only the first countermeasure for the prevailing anomaly may be selected dynamically from various available first countermeasures based on status information with respect to vehicle 30 and/or the prevailing anomaly/anomalies. In other examples, only the second countermeasure for the prevailing anomaly may be selected dynamically from various available first countermeasures based on status information with respect to vehicle 30 and/or the prevailing anomaly.

The status information may contain any item of data which characterizes an instantaneous state of vehicle 30 and/or one of its components 11, 13, 15 or historic information with respect to vehicle 30 and/or its components. In some examples, the status information may contain data concerning a history of the anomaly (e.g., with a signature of the prevailing anomaly) of vehicle 30 and/or of one of its components 11, 13. Alternatively or additionally, the status information may contain data concerning a history of anomalies of other vehicles (e.g., with a signature of the prevailing anomaly) and/or concerning the appearance of anomalies with certain signatures. Furthermore or alternatively, the status information may contain data concerning the operating status of vehicle 30 (for example, as described in detail above) or data concerning a history of the operating statuses of vehicle 30.

In some examples, the status information indicates whether the prevailing anomaly has appeared repeatedly (i.e., whether the anomaly presently detected was detected for the first time or repeatedly). Additionally or alternatively, the status information may indicate how frequently a prevailing anomaly having the signature has appeared. In some examples, the repetition or frequency may be measured within a predetermined period of time (that is, for example, detections of anomalies are only counted if they have occurred up to a maximum in a predetermined period of time prior to detection of the prevailing anomaly and/or the counting is restarted after a predetermined period of time). In some examples, a counter is provided which is increased in response to each detection of a prevailing anomaly. Different counters may be provided for different anomalies having different signatures. In other words, a record may be kept as to whether different anomalies having different signatures have appeared for the first time or repeatedly and/or how often the specific anomaly has appeared.

In one example, there may be three different anomalies with different signatures A, B, C. Three counters are now provided which count the frequency of the appearance of the anomalies having the signatures A, B, C. For instance, if an anomaly having the signature A is now detected, the counter for the anomaly having the signature A is increased by one.

In some examples, different first and/or second countermeasures may be selected in various situations, which are identified by the status information. For example, a specific first countermeasure may be selected in response to a first detection of an anomaly having a certain signature, and a different first countermeasure in response to a further detection of the anomaly having the certain signature. Alternatively or additionally, a specific second countermeasure may be selected in response to a first detection of an anomaly having a certain signature, and a different second countermeasure in response to a further detection of the anomaly with the certain signature. The first detection may be an absolutely first detection (e.g., in a certain time interval) or only a first detection in a group of two or more detections. For example, a first or second countermeasure, which is selected in response to a first detection of an anomaly having a certain signature, may entail a less severe impairment of the vehicle than a first or second countermeasure which is selected in response to a further detection of the anomaly with the certain signature (e.g., in terms of a reduction of the functional scope and/or a duration and an expenditure for carrying out the countermeasures).

In one example, a first countermeasure in response to the first detection of a specific anomaly may include changing the configuration or the operating mode of a component (e.g., first component 13 in FIG. 1). A first countermeasure in response to a further detection of the specific anomaly may include, for example, the blocking or deactivation of the component (e.g., first component 13 in FIG. 1). Additionally or alternatively, a second countermeasure in response to the first detection of a specific anomaly may include resetting the software of a component (e.g., first component 13 in FIG. 1). A second countermeasure in response to a further detection of the specific anomaly may include updating the software of the component (e.g., first component 13 in FIG. 1). In other examples, the first and second countermeasures described above may be combined in other ways as first/second countermeasure in response to the first or further detection of a specific anomaly.

In some cases, a dynamic selection of the first and/or second countermeasures may make it possible to increase the functional scope of the vehicle and/or to ensure the operating safety.

Thus, it is possible to start at first with a relatively mild countermeasure. However, if, for example, a specific anomaly should appear repeatedly after that, then it is possible to intervene more drastically in the vehicle and thus adapt the reaction.

As explained in the summary above, the present invention also relates to techniques for mitigating manipulations of an onboard network of a vehicle according to the third and fourth general aspects. These techniques also include the steps of carrying out first and second countermeasures 103, 105. Therefore, the embodiments described above of implementing the first and second countermeasures may likewise be used in the techniques according to the third and fourth general aspects.

However, the techniques of the third and fourth general aspects do not necessarily include a dynamic selection of the first or second countermeasures, as described above. Rather, a static first and a static second countermeasure may also be provided for a specific anomaly (having a specific signature). In other words, after an anomaly having a specific signature is detected, only a predetermined first and a predetermined second countermeasure may always be carried out. In other examples, however, the first and/or second countermeasures may be selected dynamically (as described above) in the techniques of the third and fourth general aspects, as well.

The techniques of the third and fourth general aspects furthermore include receiving 117 a software update so as, after the second countermeasure has been carried out, to close a vulnerable spot in the onboard network which the recognized anomaly (that is, the manipulation producing it) has utilized. In some examples, the software update may be received from a remote system 17 (e.g., via a wireless interface 27 or a wire-bound interface 29 of vehicle 30). For example, the software update may be a software update for a first component 13 of onboard network 21. After the software update has been received, the software of first component 13 may be updated 113 (and with that, the vulnerable spot may be closed). In other examples, the software update may be determined for other components of onboard network 21, as well, and their software updated.

As shown in FIG. 1, in some examples, first component 13 whose software is to be updated may be deactivated 111 prior to the update and re-activated 107 after the update. In addition, in some examples, a function of first component 13 may be shifted 111 to a second component 11 prior to the update. After the update, the function may be shifted back 107 again from second component 11 to first component 13.

In some examples, the receiving of the software update, described above, for closing the vulnerable spot may also be carried out in combination with the techniques of the first and second general aspects (e.g., subsequent to the implementation of the first and second countermeasures).

In some examples, the techniques of the present invention may also include transmitting 121 of information, which identifies a present manipulation (e.g., a present attack) in the onboard network, to a remote system 17. Additionally or alternatively, the techniques of the present invention may further include transmission 123, 125 of status updates to remote system 17 after the first and/or second countermeasure has/have been carried out. The information, which identifies a present manipulation (e.g., a present attack) in the onboard network and/or the status updates, may be processed in remote system 17 in order to select (and/or to generate) a software update that closes a vulnerable spot in onboard network 21 (e.g., a vulnerable spot that has been exploited by a manipulation or an attack which has produced the prevailing anomaly).

In some examples, one or more of the steps of the techniques described in the present disclosure may be reported to remote system 17 (e.g., detecting the signature, receiving the signature, carrying out the first countermeasure and/or carrying out the second countermeasure). In some examples, remote system 17 may likewise initiate countermeasures, carrying out or the implementation of the countermeasures.

In the above sections, it has already been discussed occasionally which components may undertake the detection and the implementation of the first and second countermeasures. In the following, these components are described in greater detail with reference to FIG. 2.

As already mentioned, a central device for mitigating manipulations may be provided, which orchestrates the implementation of the first and/or second countermeasures and/or the implementation of software updates. In the example of FIG. 1 and FIG. 2, this central device for mitigating manipulations is disposed in a central processor 15 of vehicle 30. In other examples, the central device for mitigating manipulations may be located in other components of the vehicle, for example, a central communication interface, a vehicle computer (that is, a central arithmetic-logic unit of the vehicle which controls various functions of the vehicle) or a head unit of an infotainment system. Additionally or alternatively, the central device for mitigating manipulations may be distributed over several components. In other examples, the central device for mitigating manipulations may also be a dedicated component. In some examples, the central device for mitigating manipulations may also be located in remote system 17 (which, however, in some examples, can prolong a reaction time of the central device for mitigating manipulations). In other examples, the steps of selecting and carrying out the first countermeasure and selecting and carrying out the second countermeasure are performed by components within vehicle 30.

The present invention also relates to a system which is designed to put the techniques of the present invention into practice. The system may be contained in the vehicle and/or be connected to the vehicle (e.g., via a wireless interface).

The systems, components, modules or units of the present invention may have any hardware and/or software suitable for providing the functionalities described. The components or modules may in each case include at least one processor (possibly with several cores) and a memory, that includes commands which, when they are executed by the processor, carry out the methods of the present invention. The components, modules or units may be implemented as a stand-alone system or as a distributed system (e.g., with one part on a remote system and/or in a cloud memory). In other examples, the components or modules may be integrated into a higher-level system.

The present invention also relates to a computer program which is designed to carry out the methods according to the present invention.

The present invention also relates to a machine-readable medium (e.g., a storage medium) or signal (wireless or wire-bound) which contains/encodes the computer program according to the present invention.

1-12. (canceled)

13. A method for mitigating manipulations of an onboard network of a vehicle, the method comprising the following steps:
receiving a signature of an anomaly prevailing in the onboard network;
implementing a first countermeasure which transfers the vehicle and/or at least one component of the vehicle, into a predetermined safe state, the first countermeasure being selected based on the signature; and
implementing a second countermeasure to at least partially restore a functional scope of the vehicle;
wherein the first and/or the second countermeasure for the prevailing anomaly is selected dynamically from various available countermeasures based on status information with respect to the vehicle and/or the prevailing anomaly.

14. The method as recited in claim 13, wherein the status information indicates whether the prevailing anomaly has appeared repeatedly.

15. The method as recited in claim 13, wherein the status information indicates how frequently an anomaly having the signature has appeared.

16. The method as recited in claim 13, wherein different first and/or second countermeasures are selected in various situations, which are identified by the status information.

17. The method as recited in claim 16, wherein a certain first and/or second countermeasure is selected in response to a first detection of an anomaly having a specific signature, and a different first and/or second countermeasure in response to a further detection of the anomaly having the specific signature.

18. The method as recited in claim 13, wherein the first countermeasure is intended to be carried out within a first predetermined time interval after an anomaly is detected, the predetermined time interval being 20 seconds or less.

19. The method as recited in claim 13, wherein the first countermeasure is intended to be carried out within a first predetermined time interval after an anomaly is detected, the predetermined time interval being 2 seconds or less.

20. The method as recited in claim 13, wherein the first countermeasure is intended to be carried out within a first predetermined time interval after an anomaly is detected, the predetermined time interval being 20 ms or less.

21. The method as recited in claim 13, wherein the first countermeasure includes one or more of the following:
at least partially deactivating or blocking a first component of the onboard network, in which the prevailing anomaly has appeared;
activating a component or a function which is affected by the prevailing anomaly;
shifting a function of a first component in which the prevailing anomaly has appeared, to a second component;
changing a configuration of a first component of the onboard network in which the prevailing anomaly has appeared, and/or of further components of the onboard network;
changing an operating mode of a first component of the onboard network in which the prevailing anomaly has appeared, and/or of further components of the onboard network;
transmitting a warning that a signature of an anomaly was detected.

22. The method as recited in claim 13, wherein the second countermeasure includes one or more of the following:
resetting a software of a first component of the onboard network in which the prevailing anomaly has appeared, and/or of further components of the onboard network;
updating a software of a first component of the onboard network in which the prevailing anomaly has appeared, and/or of further components of the onboard network;
reactivating a first component or lifting a blockade of a first component of the onboard network, in which the prevailing anomaly has appeared;
shifting a function back from a second component to a first component in which the prevailing anomaly has appeared;
changing a configuration of a first component of the onboard network in which the prevailing anomaly has appeared, and/or of further components of the onboard network; and
changing an operating mode of a first component of the onboard network in which the prevailing anomaly has appeared, and/or of further components of the onboard network.

23. The method as recited in claim 13, wherein the method is carried out by one or more components within the vehicle.

24. A system configured to mitigate manipulations of an onboard network of a vehicle, the system configured to:
receive a signature of an anomaly prevailing in the onboard network;
implement a first countermeasure which transfers the vehicle and/or at least one component of the vehicle, into a predetermined safe state, the first countermeasure being selected based on the signature; and
implement a second countermeasure to at least partially restore a functional scope of the vehicle;
wherein the first and/or the second countermeasure for the prevailing anomaly is selected dynamically from various available countermeasures based on status information with respect to the vehicle and/or the prevailing anomaly.

25. A non-transitory machine-readable medium on which is stored a computer program for mitigating manipulations of an onboard network of a vehicle, the computer program, when executed by a computer, causing the computer to perform the following steps:
receiving a signature of an anomaly prevailing in the onboard network;
implementing a first countermeasure which transfers the vehicle and/or at least one component of the vehicle, into a predetermined safe state, the first countermeasure being selected based on the signature; and
implementing a second countermeasure to at least partially restore a functional scope of the vehicle;
wherein the first and/or the second countermeasure for the prevailing anomaly is selected dynamically from various available countermeasures based on status information with respect to the vehicle and/or the prevailing anomaly.
